(19) United States
(12) Patent Application Publication
(10) Pub. No.: US 2011/0188124 A1
(43) Pub. Date: Aug. 4, 2011

(54) METHOD FOR MANUFACTURING IMAGE PRINT SHEET, IMAGE PRINT SHEET AND PRINTING APPARATUS

(76) Inventors: Satoshi YANAGITA, Saitama-shi (JP); Ryo Imai, Saitama-shi (JP); Maki Saito, Saitama-shi (JP); Kenji Saito, Saitama-shi (JP); Atsushi Misawa, Saitama-shi (JP)

(21) Appl. No.: 13/013,909

(22) Filed: Jan. 26, 2011

(30) Foreign Application Priority Data
Jan. 29, 2010 (JP) P2010-019001

(51) Int. Cl. G02B 27/12; B41N 1/00

(52) U.S. Cl. 359/619; 101/401.1

(57) ABSTRACT

Present invention provides an image print sheet printable in high accuracy without reducing productivity. After a lenticular sheet 101 and a reception layer sheet 102 on which a detection pattern 103 is printed are inserted in an attachment apparatus 110 from insertion openings, the optical density is measured repeatedly by a density sensor 111 while rotating and parallel-moving the lenticular sheet 101. When the maximum density is measured, the reception layer sheet 102 is attached to the lenticular sheet 101. In this way, an image print sheet 100 having the detection pattern 103 parallel to the longitudinal direction of convex parts 101a and coinciding with the vertexes of the convex parts 101a is produced. When printing on the image print sheet 100, the detection pattern is detected by a photo-sensor, an azimuth adjustment and a print start position determination will be performed. Consequently, printing with high accuracy is available.

### BACKGROUND I/F THE INVENTION

1. Field of the Invention

The present invention relates to a method for manufacturing image print sheet, image print sheet and printing apparatus, and more particularly to a method for manufacturing image print sheet, image print sheet and printing apparatus capable of manufacturing three-dimensional image photo print (hereinafter referred to as “3D print”).

2. Description of the Related Art

JP3471930B discloses an inkjet recording apparatus which records an identification image on a margin, and based on the printed identification image, the apparatus detects the displacement of a print image against the lenticular sheet.

JP2007-127521A discloses a printing apparatus which reads a lenticular sheet with a scanner and calculates the pattern information corresponding to the lens pitch of the lenticular sheet.

JP2007-76084A discloses a printing apparatus which detects the position of a convex lens and controls the position of the image print means according to the detected position so as to align an image to be recorded with the lenticular sheet, and the aligned image will be printed thereafter using the apparatus.

### SUMMARY I/F THE INVENTION

In the invention described in JP3471930B, due to the recording of the identification image in a marginal region, the marginal region increases. Therefore, problems of less efficient usage of a lenticular sheet and increase of printing time occur.

The invention described in JP2007-127521A requires the usage of a scanner and therefore the apparatus may become expensive.

In the invention described in JP2007-76084A, the image print means (printing apparatus) performs the alignment and therefore tilting occurs (the forward moving direction of the image print means tilted against the direction perpendicular with respect to the longitudinal direction of the lenses of a lenticular sheet), and a recorded image tends to be distorted. Furthermore, due to the provision of the alignment mechanism, the printing apparatus may become complex in structure and may increase size and cost of the apparatus.

The present invention is made in view of the above-mentioned problems and the object of the present invention is to provide a method for manufacturing image print sheet capable of manufacturing an image print sheet in which three-dimensional image can be printed with high-accuracy in a simple manner without reducing productivity, an image print sheet capable of printing in high-accuracy without reducing productivity, and a printing apparatus capable of printing in high-accuracy without reducing productivity.

In order to achieve the aforementioned object, according to a first aspect of the invention, there is provided a method for manufacturing image print sheet, including a printing step for printing a pattern on an optically transparent reception layer sheet and an attachment step for attaching the reception layer sheet printed with the pattern to a flat surface of a lenticular sheet, the sheet being provided with a strips of convex part having nearly arc-shaped cross-section which are continuously aligned in parallel to each other on one surface of an optically transparent substrate meanwhile the flat surface is on the other surface of the optically transparent substrate. Note that, the term “flat” surface means a surface in flat state as a whole which include a surface in nearly flat state.

In the method for manufacturing image print sheet according to the first aspect of the invention, a reception layer sheet on which a pattern is printed is attached to the flat surface of a lenticular sheet. The lenticular sheet comprises strips of convex parts having a nearly arc-shaped cross-section which are continuously aligned in parallel to each other on one surface of an optically transparent substrate where the flat surface on the other surface. Therefore, an image print sheet which a detection pattern (identification image) is recorded can be manufactured in a simple method with ease. Furthermore, an image print sheet on which a detection pattern is recorded can be provided to the user. Then, using the image print sheet on which a detection pattern is recorded, the user can easily print three-dimensional images with high accuracy. Furthermore, a large quantity of lenticular sheets on which a detection pattern is printed can be stocked. Using the stocked lenticular sheets as necessary, the print step in printing a recording image will be simplified and the print time will be saved, which will result in improving the productivity. Furthermore, due to the un-necessity of providing a printing apparatus with the alignment mechanism, the printing apparatus will be simplified in structure and will not increase in size or cost.

Furthermore, it is preferable in the method for manufacturing an image print sheet according to the first aspect of the invention that in the printing step, lines are printed as the pattern on the reception layer sheet, and in the attachment step, the reception layer sheet is attached to the lenticular sheet in a manner that the pattern is parallel to the longitudinal direction of the convex part.

With the above-mentioned method, the reception layer sheet is attached to the lenticular sheet with the linear pattern in parallel to the longitudinal direction of the convex parts. In this way, the direction of the convex parts of the image print sheet can be identified with ease. Then, the azimuth adjustment and convex part pitch detection can be done. For the method of detecting the convex part pitch from the linear pattern, the distance between two lines (in the longitudinal direction of the convex parts or in the direction perpendicular with respect to the longitudinal direction of the convex parts) or the length of lines can be used.

Furthermore, it is preferable in the method for manufacturing an image print sheet according to the first aspect of the invention that in the attachment step, the reception layer sheet is attached to the lenticular sheet in the manner that the pattern coincides with the vertex of the convex parts or the trough between the convex parts.

With the above-mentioned method, the reception layer sheet is attached to the lenticular sheet with the linear pattern in parallel to the longitudinal direction of the convex parts and coinciding with the vertexes of the convex parts or the troughs between the convex parts. In this way, the positions of the convex parts of the image print sheet can be identified with ease.

Furthermore, it is preferable in the method for manufacturing an image print sheet according to the first aspect of the invention that the printing step, two or more lines are printed as the pattern aligned in an distance equal to the distance between the convex parts.

With the above-mentioned method, two or more lines are printed in a distance equal to the distance between the convex parts on the reception layer sheet and the reception layer sheet is attached to the lenticular sheet with two lines aligned in parallel with respect to the longitudinal direction of the convex parts. In this way, the pitch of the convex parts of the image print sheet can be identified with ease. Moreover, the print start position of the image print sheet can be detected.

In addition, it is preferable in the method for manufacturing an image print sheet according to the first aspect of the invention that in the printing step, two or more lines are printed as the pattern aligned in a row with a predetermined distance.

With the above-mentioned method, two or more lines are printed in lines at predetermined distance on the reception layer sheet and the reception layer sheet is attached to the lenticular sheet with two or more lines aligned in parallel with respect to the longitudinal direction of the convex parts. In this way, the pitch of the convex parts of the image print sheet can be identified with ease. Moreover, the print start position of the image print sheet can be detected.

In addition, it is preferable in the method for manufacturing an image print sheet according to the first aspect of the invention to further include a step of making a predetermined surface of the reception layer sheet adhesive, wherein, in the printing step, the pattern is printed on the surface that is not made adhesive, and in the attachment step, the surface that is made adhesive is attached to the flat surface.

Furthermore, it is preferable in the method for manufacturing an image print sheet according to the first aspect of the invention that in the printing step, the pattern is printed on a predetermined surface, the method further includes a step of making the surface on which the pattern is printed or the surface on which the pattern is not printed adhesive, and in the attachment step, the adhesive side is attached to the flat surface.

Furthermore, it is preferable in the method for manufacturing an image print sheet according to the first aspect of the invention that the attachment step comprising, a first step for placing the reception layer sheet on which a pattern is printed on to the flat surface of the lenticular sheet, a second step for detecting the pattern from the side of the lenticular sheet on which the convex parts are formed, a third step for determining whether the reception layer sheet and lenticular sheet have an appropriate positional relationship based on the detected result in the step of detecting the pattern, and a fourth step for attaching the reception layer sheet to the lenticular sheet when the appropriate positional relationship is confirmed in the step of determination.

With the above-mentioned method, the reception layer sheet on which a pattern is printed is placed on the flat surface of the lenticular sheet and then the pattern is detected from the side of the lenticular sheet on which the convex parts are formed. Thereafter, based on the detected result, it is determined whether the reception layer sheet and lenticular sheet have the appropriate positional relationship. If the appropriate positional relationship is confirmed, then the reception layer sheet is attached to the lenticular sheet. In this way, the reception layer sheet and lenticular sheet can be aligned in a simple manner without separately measuring their positions.

Furthermore, it is preferable in the method for manufacturing an image print sheet according to the first aspect of the invention that in the second step, the density of a predetermined region is detected, and in the third step, the appropriate positional relationship is confirmed when the predetermined region has the maximum density or the minimum density.

With the above-mentioned method, the density of a predetermined region will be detected from the side of the lenticular sheet on which the convex parts are formed. The appropriate positional relationship between the reception layer sheet and lenticular sheet will be confirmed when the predetermined region has the maximum density or the minimum density. In this way, the appropriate positional relationship between the reception layer sheet and lenticular sheet can be confirmed if the pattern is parallel to the longitudinal direction of the convex parts and coincides with the vertexes of the convex parts or the troughs between the convex parts.

Furthermore, it is preferable in the method for manufacturing an image print sheet according to the first aspect of the invention that in the second step, the thickness of the pattern is detected, and in the third step, the appropriate positional relationship is confirmed when the pattern has a constant thickness.

With the above-mentioned method, the thickness of the pattern is detected from the side of the lenticular sheet on which the convex parts are formed. The appropriate positional relationship between the reception layer sheet and lenticular sheet is confirmed if the pattern has a constant thickness. In this way, the appropriate positional relationship between the reception layer sheet and lenticular sheet can be confirmed if the pattern is parallel to the longitudinal direction of the convex parts.

In addition, it is preferable in the method for manufacturing an image print sheet according to the first aspect of the invention that in the third step, the appropriate positional relationship is confirmed when the pattern has the maximum thickness or the minimum thickness

With the above-mentioned method, the thickness of the pattern is detected from the side of the lenticular sheet on which the convex parts are formed, and the appropriate positional relationship between the reception layer sheet and lenticular sheet will be confirmed if the pattern has a constant thickness with the maximum thickness or the minimum thickness. In this way, the appropriate positional relationship between the reception layer sheet and lenticular sheet can be confirmed when the pattern is parallel to the longitudinal direction of the convex parts and coincides with the vertexes of the convex parts or the troughs between the convex parts.

Moreover, in order to achieve the aforementioned object, according to a second aspect of the invention, there is provided an image print sheet comprising a lenticular sheet having multiple half-cylinder or arc-shaped elongated convex parts aligned on one surface of an optically transparent substrate where the other surface of an optically transparent substrate is flat surface, and an optically transparent reception layer sheet placed on the flat surface of the lenticular sheet and on which a linear pattern parallel to the convex parts coinciding with the centers of the convex parts or the troughs between the convex parts is printed.

In the image print sheet according to the second aspect of the invention the sheet comprises a lenticular sheet having multiple half-cylinder or arc-shaped elongated convex parts aligned on one surface of an optically transparent substrate where the other surface of an optically transparent substrate is flat surface, and a linear pattern parallel to the convex parts coinciding with the centers of the convex parts or the troughs between the convex parts is printed. In this way, three-dimensional images can be printed with high accuracy.

Furthermore, it is preferable in the image print sheet according to the second aspect of the invention that two or more lines are printed as the pattern in a distance equal to the distance between the convex parts on the reception layer sheet.

With the above-mentioned configuration, a pattern consisting of two or more lines spaced in a distance equal to the distance between the convex patterns is printed in the manner that it is parallel to the convex parts and coincides with the centers of the convex parts or the troughs between the convex parts. In this way, the pitch of the convex parts of the image print sheet can be identified with ease. Moreover, the print start position of the image print sheet can be detected.

Furthermore, it is preferable in the image print sheet according to the second aspect of the invention that two or more lines are printed in a row as the pattern in a predetermined distance on the reception layer sheet.

With the above-mentioned configuration, a pattern consisting of two or more lines arranged in a row at predetermined distance are printed. In this way, the pitch of the convex parts of the image print sheet can be identified with ease. Moreover, the print start position of the image print sheet can be detected.

Furthermore, it is preferable in the image print sheet according to the second aspect of the invention that the image print sheet has marginal regions near the ends of the image print sheet and an image print region in which an image is printed, and the pattern is printed in the image print region.

With the above-mentioned configuration, the pattern is printed in the print region. In this way, provision of a marginal region for recording a pattern is unnecessary, and therefore the image print sheet can be used efficiently.

Moreover, in order to achieve the aforementioned object, according to a third aspect of the invention, there is provided a printing apparatus comprising a conveying part for conveying the image print sheet, a detection part for detecting the pattern on the image print sheet conveyed by the conveying part, a rotation part for rotating the image print sheet based on the pattern detected by the detection part, and a print part for printing the image on the image print sheet based on the pattern detected by the detection part.

In the printing apparatus according to the third aspect of the invention, an image print sheet on which a pattern is printed is conveyed, the pattern is detected on the conveyed image print sheet, the image print sheet is rotated based on the detected pattern, and a print is made on image print sheet based on the detected pattern. In this way, the tilting rate and pitch of convex parts of the image print sheet can be obtained with the simple structure.

Furthermore, it is preferable in the printing apparatus according to the third aspect of the invention that the apparatus comprising a determination part determining the print start position based on the pattern detected by the detection part, wherein the print part makes a print from the print start position determined by the determination part.

With the above-mentioned configuration, the print start position is determined based on the pitch of the detected pattern and the print starts from the determined print start position. In this way, the print start position of the image print sheet can be determined with the simple structure.

As mentioned-above, the present invention enables the manufacturing of an image print sheet which enables three-dimensional printing in high accuracy with a simple method without reducing productivity, and enabling highly accurate printing using the image print sheet.

### BRIEF DESCRIPTION I/F THE DRAWINGS

FIG. 1 is an internal transparent view schematically showing inside of a printing apparatus 10 with a print medium being supplied.

FIG. 2 is a perspective view showing the schematic configuration of a clamper and clamper conveying part.

FIG. 3 is a plan view showing the schematic configuration of the clamper and clamper conveying part.

FIG. 4 is a block diagram showing the core configuration of the printing apparatus.

FIGS. 5A and 5B are schematic views showing a lenticular sheet. 5A: a side view, 5B: a plan view.

FIG. 6 is a flowchart showing the process of manufacturing method of a lenticular sheet.

FIG. 7 is a schematic view showing an attachment apparatus of the lenticular sheet.

FIG. 8 is a schematic view showing a reception layer sheet.

FIG. 9 is a view showing the effect of a convex part of the lenticular sheet.

FIG. 10 is a flowchart of the print process.

FIG. 11 is a flowchart showing the azimuth adjustment and print start position determination process.

FIGS. 12A and 12B are schematic views showing the relationship between the image print sheet conveying direction and the detection results of the photo-interrupters 40 and 42. 12A: when the conveying direction is nearly perpendicular with respect to the longitudinal direction of the convex part, and 12B: when the conveying direction is not perpendicular with respect to the longitudinal direction of the convex parts.

FIGS. 13A and 13B are schematic views showing other embodiments of the lenticular sheet.

### DESCRIPTION I/F THE PREFERRED EMBODIMENTS

Hereinafter, exemplary embodiments of the method for manufacturing image print sheet, image print sheet and printing apparatus according to the present invention will be described with reference to the accompanying drawings.

### [Entire Configuration of the Printing Apparatus]

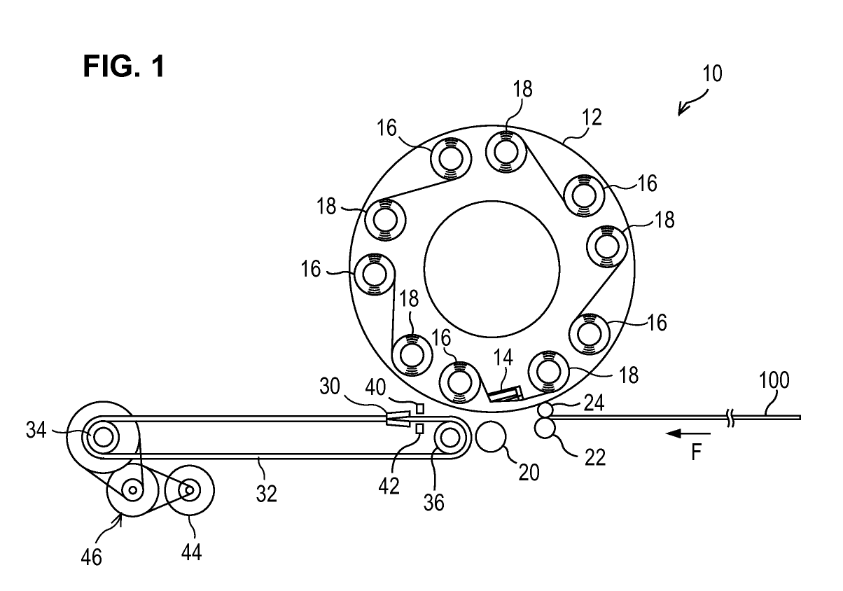

FIG. 1 is an internal transparent view schematically showing a printing apparatus 10 according to the present invention with an image print sheet being supplied.

As shown in FIG. 1, the printing apparatus 10 is a 3D printer in which a transparent resin image print sheet 100 (which will be described in detail below) is horizontally conveyed for printing the image. The image print sheet has a lens surface on which a lenticular lens consisting of a group lenses are formed and a printing surface on the other side of the lens surface.

Furthermore, the printing apparatus 10 is a sublimation printer using yellow (Y), magenta (M), cyan (C) and white (W) ink ribbons, repeating the forward movement (for printing, refer to the arrow “F” in FIG. 1) and the backward movement (for moving back to the print start position) for each printing color.

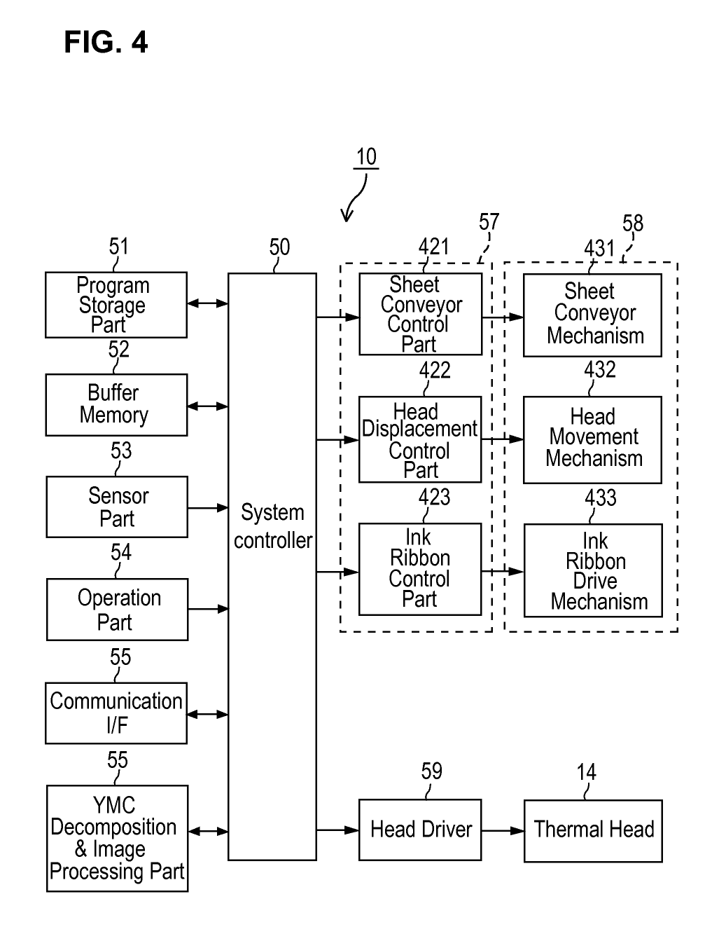

As shown in FIG. 1, the printing apparatus 10 is mainly composed of a sheet conveying mechanism 431 (refer to FIG. 4) which conveys an image print sheet 100 mainly when printing the image, a ribbon exchange gatling mechanism on which at least Y, M, C and W ink ribbons are mounted, and a thermal head 14.

### [Sheet Conveying Mechanism]

The sheet conveying mechanism 431 is mainly composed of a conveying roller 22, a capstan 24, a clamper 30 and a clamper conveying part moving the clamper 30.

With the image print sheet inserted from insertion opening (not shown), the leading end of the image print sheet 100 reaches the position at the conveying roller 22 as shown in FIG. 1. Then, due to the press bonding of the capstan 24 against the conveying roller 22 via the image print sheet 100 and the driving of the conveying roller 22, image print sheet 100 will be conveyed.

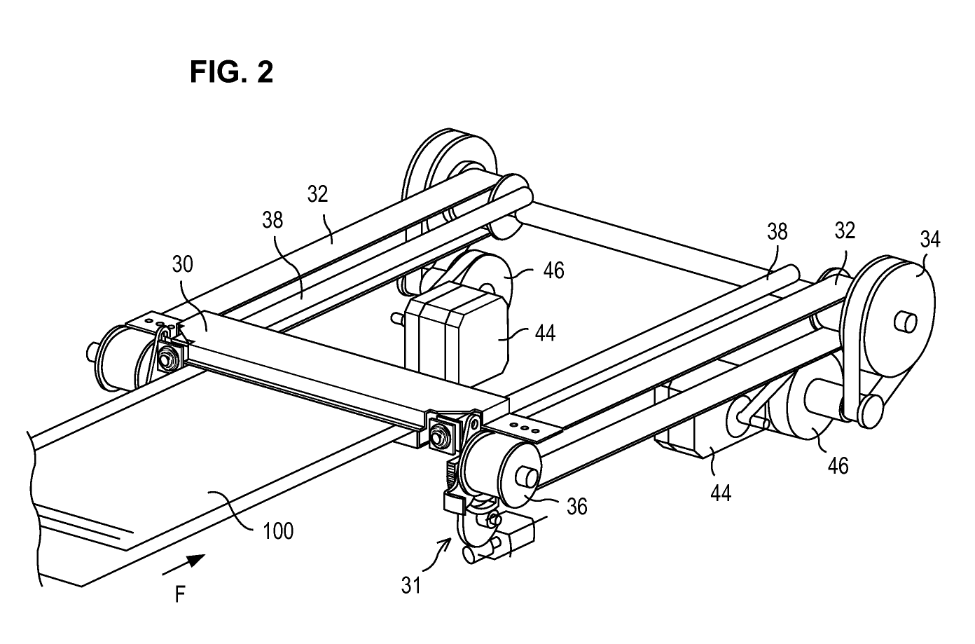

The image print sheet 100 is conveyed by the conveying roller 22 and capstan 24 until the leading end of the image print sheet 100 reaches the clamper 30 standing by at the initial position (the rightmost position of the moving range of the clamper 30 in FIG. 1). Note that, the clamper 30 consists of a pair of clamping members normally biased by a spring to a closing direction. Meanwhile, in the above-mentioned standby state, by using an open/close mechanism 31 (refer to FIG. 2) consisting of a cam or the like, the pair of clamping members will be opened against the biasing force of the spring.

As the leading end of the image print sheet 100 reaches the clamper 30, the clamper 30 clamps the leading end of the image print sheet 100 and the capstan 24 (refer to FIG. 1) retracts from the conveying roller 22. Then, the image print sheet 100 together with the clamper 30 will be conveyed by the clamper conveying part.

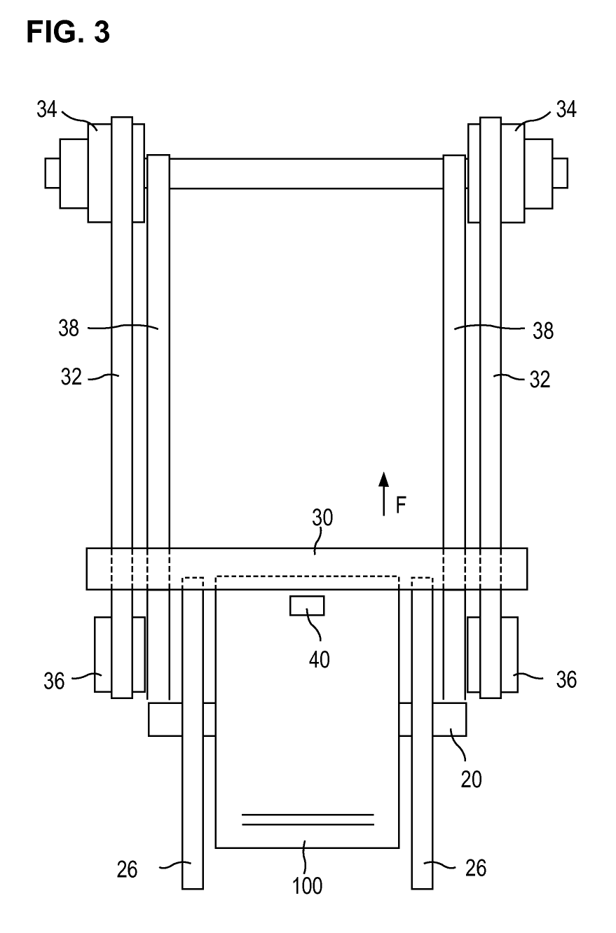

FIGS. 2 and 3 are plan views showing the schematic configuration of the clamper 30 and clamper conveying part. The clamper conveying part is mainly composed of drive belts 32, drive pulleys 34, driven pulleys 36 and guide rails 38.

A pair of drive pulleys 34 driven respectively using drive motors 44 via deceleration mechanisms 46 is provided at the left end part in FIG. 1. Moreover, a pair of driven pulleys 36 is provided adjacent to a platen roller 20.

The drive belts 32 are winded around the drive pulleys 34 and driven pulleys 36. Moreover, as shown in FIG. 2, the clamper 30 is fixed between the drive belts 32 with bolts (not shown).

Furthermore, the guide rails 38 guiding the clamper 30 in the vertical direction along the drive belts 32 are provided. Moreover, resin guides 26 (refer to FIG. 3) guiding the image print sheet 100 to the clamper 30 in a standby state at the initial position are provided. Note that, the resin guide 26 can be replaced with a rubber guide.

A distance between two resin guides 26 is larger than the width of the image print sheet 100 with a predetermined clearance. The resin guides 26 guide the image print sheet 100 along the vertical direction.

As shown in FIGS. 1 and 3, photo-interrupters 40 and 42 are provided between the platen roller 20 and clamper 30. The light emitting photo-interrupter 40 is provided above the conveying path of the image print sheet 100 (on the same side as the ribbon cage 12) and the light-receiving photo-interrupter 42 is provided at the opposite position to the photo-interrupter 40 across the conveying path of the image print sheet 100.

Detection signal of image print sheet 100 are detected by the photo-interrupter 42, and when the photo-sensor optical axis coincides with the centers of the lenses of the image print sheet 100, the detected signal indicate the maximum value, wherein, when it coincides with the troughs between the lenses, the detected signal indicate the minimum value. Therefore, the tilting (azimuth angle) of the image print sheet 100 can be detected based on the detection signals of the photo-interrupters 40 and 42.

The azimuth adjustment (adjusting the azimuth angle to zero) on the image print sheet 100 will be conducted as follows. First, the leading end of the image print sheet 100 is clamped by the clamper 30 and then the right and left pair of drive pulleys 34 is driven independently to slightly incline the clamper 30 by an azimuth adjustment rate.

After the azimuth adjustment is done as described above, the clamper 30 is moved forward (in the arrowed “F” direction in FIG. 1) to convey the image print sheet 100 to the print start position. Then, the printing with the thermal head 14 starts. After printing in one color, the drive pulleys 34 are reversed to parallelly-move the clamper 30 to the right (the direction opposite to the arrow “F”) in FIG. 1 so that the image print sheet 100 is returned to the print start position.

### [Ribbon Exchange Gatling Mechanism and Thermal Head]

As shown in FIG. 1, the ribbon exchange gatling mechanism has a ribbon cage 12, rewind reels 16 and feed reels 18.

The ribbon cage 12 is provided with five pairs of rewind reels 16 and feed reels 18 in a equal distance R, Y, M, C and W ink ribbons are set to the five pairs of reels, respectively. The ribbon cage 12 is rotated by a gatling mechanism (not shown) to move a desired ribbon to the position of the thermal head 14. Note that, in the present embodiment, since the image print sheet 100 (which will be described in detail below) contains a reception layer, another ink ribbon can be set in place of the R (reception layer) ink ribbon.

Of a pair of rewind reel 16 and feed reel 18 moved to the position of the thermal head 14, the rewind reel 16 rewinds the ink ribbon via a friction clutch at a speed slightly faster than the moving speed of the image print sheet 100 during printing and the feed reel 18 is braked to apply a predetermined back tension to the ink ribbon. In this way, as the image print sheet 100 moves during printing, the ink ribbon is fed along with (synchronized with) the movement of the image print sheet 100.

The thermal head 14 is provided in the ribbon cage 12. A head moving mechanism 432 (refer to FIG. 4) places the thermal head 14 at a print position where it abuts against the platen roller 20 via an ink ribbon and the image print sheet 100 during printing and retracts the thermal head 14 to a retracted position where it is retracted from the platen roller 20 while an ink ribbon is exchanged or the image print sheet 100 is moved backward.

Furthermore, the thermal head 14 is driven according to 3D multi-viewpoint images (six-viewpoint images in this embodiment) and sublimates the ink on the ink ribbon to transferring it to the image print sheet 100, which will be described below.

### [Explanation of Printing Apparatus Control System]

The control system of the printing apparatus 10 with the above-mentioned configuration will be described hereinafter.

FIG. 4 is a block diagram showing the core configuration of the printing apparatus 10.

The printing apparatus 10 is composed of a system controller 50, a program storage part 51, a buffer memory 52, a sensor part 53, an operation part 54, a communication interface (communication I/F) 55, a YMC analysis/image processing part 56, a control part 57, a mechanism part 58, a head driver 59 and a thermal head 14.

The system controller 50 collectively controls each part using 3D print programs and possibly consists of a CPU (central processing unit). The program storage part 51 consists of a computer-readable nonvolatile storage medium such as a ROM which stores 3D print programs. The system controller 50 reads and executes programs stored in the program storage part 51 as necessary.

The buffer memory 52 temporarily stores two-viewpoint images (right and left images) received from a not-shown personal computer (PC) or digital camera via the communication I/F 55 and image data generated by the YMC analysis/image processing part 56.

The sensor part 53 includes sensors detecting the position and rotation angle of the photo-interrupters 40 and 42 and members of the mechanical part 58 shown in FIG. 4 and outputs the detected detection signals to the system controller 50.

The sensor part 53 detects a detection pattern 103 (which will be described in detail below) recorded on the image print sheet 100 and outputs the detected detection signals to the system controller 50. The system controller 50 detects the rotation rate (tilting rate) of the image print sheet 100 with respect to the conveying path of the image print sheet 100 and the pitch A (which will be described in detail below) and print start position of the image print sheet 100 based on the detection signals.

The operation part 54 is composed of a power switch, a print start switch, a switch for setting the number of prints and the like. Signals generated upon operation of the operation part 54 are supplied to the system controller 50.

The YMC analysis/image processing part 56 acquires two-viewpoint images (right and left images) obtained by photographing the same object using a 3D camera, and calculates the shift rate of characteristic points having the same characteristics from the right and left images (the shift rate between pixels (parallax quantity)) on the basis of pixels. The calculated parallax quantity is adjusted for 3D printing and the adjusted parallax quantity is interpolated to create six-viewpoint images. A PC further performs color conversion from R, G and B, to Y, M and C on the six-viewpoint images, and generates Y, M, and C signals for one image from the color-converted six-viewpoint images.

The YMC analysis/image processing part 56 corrects the Y, M and C signals for one image according to the pitch A of the image print sheet 100 as necessary when the pitch of the generated Y, M and C signals for one image is different from the pitch A of the image print sheet 100.

Note that, it is possible to execute the procedures performed by above-mentioned YMC analysis/image processing part 56 on a PC connected via the communication I/F 55 and receive the results via the communication I/F 55.

The system controller 50 outputs control signals to the control part 57 according to the print sequence and drives/controls the mechanism part 58 via the control part 57.

The control part 57 is composed of a sheet conveying control part 421, a head movement control part 422 and an ink ribbon control part 423.

The mechanism part 58 is composed of a sheet conveying mechanism 431, a head moving mechanism 432 and an ink ribbon drive mechanism 433.

The sheet conveying mechanism 431 is composed of the conveying roller 22, capstan 24, clamper 30, and clamper conveying part including the drive motors 44 as shown in FIG. 1 and other figures. The sheet conveying control part 57 conveying the image print sheet 100 inserted via the sheet conveying mechanism 431 to the platen roller 20 and parallelly-moves the image print sheet 100 during printing.

The head moving mechanism 431 includes a not-shown actuator. The head movement control part 422 moves the thermal head 14 between the print position where it abuts against the platen roller 20 and the retracted position via the head moving mechanism 432.

The ink ribbon drive mechanism 433 is composed of a gatling mechanism (not shown) rotating the ribbon cage 12, and a reel drive mechanism driving five pairs of rewind reels 16 and feed reels 18 provided in the ribbon cage 12. The ink ribbon control part 423 rotates the ribbon cage 12 via the ink ribbon drive mechanism 433 and feeds the ink ribbons.

The thermal head 14 has a number of heater elements arranged in the direction perpendicular to the conveying direction of the image print sheet 100. The system controller 50 controls the temperature of the heater elements via the head driver 59 based on print data stored in the buffer memory 52 so that the density corresponding to the print data is obtained for each line, sublimates the ink of the ink ribbon to transferring it to the image print sheet 100, advances the image print sheet 100 by one line via the sheet conveying mechanism 431, and repeats these operations for thermal transferring line by line.

### [Image Print Sheet]

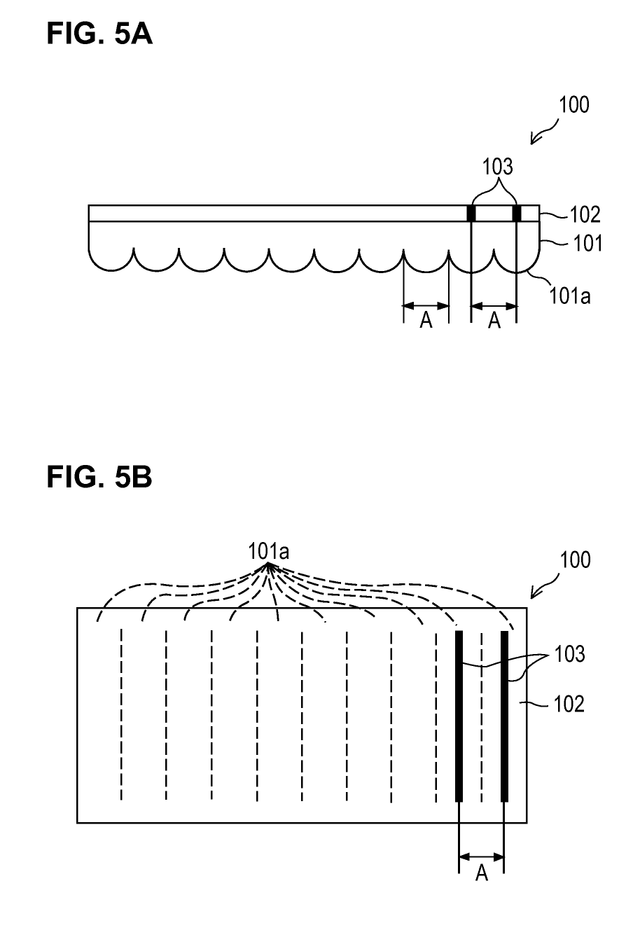

FIGS. 5A and 5B are schematic views of the image print sheet 100 where FIG. 5A is a cross-sectional view of the image print sheet 100 and FIG. 5B is a plan view of the image print sheet 100.

The image print sheet 100 mainly consists of a lenticular sheet 101 and a reception layer sheet 102. The image print sheet 100 has a print region in which an image is actually printed and marginal regions around the print region.

The lenticular sheet 101 is a plate-like member having strips of convex parts 101a (lenses) having a nearly arc-shaped cross-section and continuously formed in a predetermined pitch A on one surface (hereinafter referred to as “front surface”) and a nearly flat surface on the other surface (hereinafter referred to as “rear surface”). The pitch A of the convex parts 101a is the distance between convex parts 101a, namely the distance between the centers of adjacent convex parts 101a or the distance between the troughs of adjacent convex parts 101a as shown in FIG. 5A.

The lenticular lens 101 is made of a flexible transparent resin having thermal resistance corresponding to the printing operation of the thermal head 14, such as polycarbonate (PC), polyethylene terephthalate (PET) and acryl (PMMA). The lenticular sheet 101 can have any thickness, which is, for example, 0.3 mm.

The reception layer sheet 102 is a base member in the form of a transparent sheet absorbing ink and fixing Y, M, C and W color materials. Moreover, the reception layer sheet 102 is provided on the rear surface of the lenticular sheet 101. The reception layer sheet 102 is a flexible member made of an optically transparent material and is formed in the manner that an image can be printed on either side. Note that, the reception layer sheet 102 can be transparent or translucent as long as it is optically transparent.

The reception layer sheet 102 is made thermal adhesive by applying a thermal adhesive on one surface. The surface on which a thermal adhesive is applied is superpositioned on the rear surface of the lenticular sheet 101. Then, the reception layer sheet 102 is heated from above so that the reception layer sheet 102 is attached to the rear surface of the lenticular sheet 101. In this embodiment, the reception layer sheet 102 is made thermal adhesive and heated to attach it to the lenticular sheet 101. The method of attaching the reception layer sheet 102 to the lenticular sheet 101 is not restricted to the above-mentioned process. For example, an adhesive can be applied to make the reception layer sheet 102 adhesive. In such case, the surface of the reception layer sheet 102 that is made adhesive is superpositioned on the rear surface of the lenticular sheet 101 and the reception layer sheet 102 is pressed against the lenticular sheet 101 from above to attach the reception layer sheet 102 to the rear surface of the lenticular sheet 101.

The detection pattern 103 consists of two lines recorded on the reception layer sheet 102. The detection pattern 103 is recorded in the manner that it is parallel to the longitudinal direction of the convex parts 101a and coincides with the centers of the convex parts 101a (the highest point of the convex shape). The distance between two lines of the detection pattern 103 in the direction perpendicular with respect to the longitudinal direction of the convex parts is equal to the pitch A of the convex parts 101a. Therefore, by detecting the detection pattern 103, the pitch A of the convex parts 101a of the image print sheet 100 can be identified easily.

Note that, in this embodiment, the recorded detection pattern 103 has nearly the same length as the print region of the image print sheet 100. The length of the detection pattern 103 is not restricted thereto and can be shorter. Moreover, the detection pattern 103 consists of two lines in this embodiment. Furthermore, the detection pattern 103 can consist of one line or three or more lines.

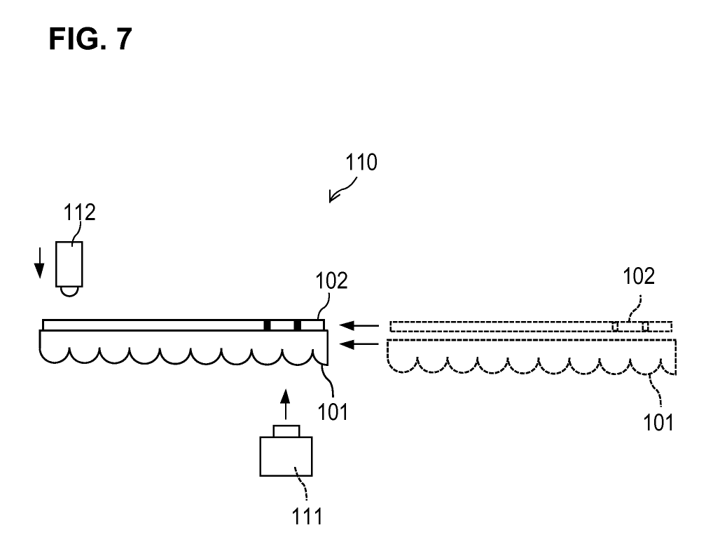

Hereinafter, a method for manufacturing the image print sheet 100 will be described. The image print sheet 100 is manufactured by attaching a reception layer sheet 102 on which a detection pattern 103 is recorded to a lenticular sheet 101 using a dedicated attachment apparatus 110 (refer to FIG. 7).

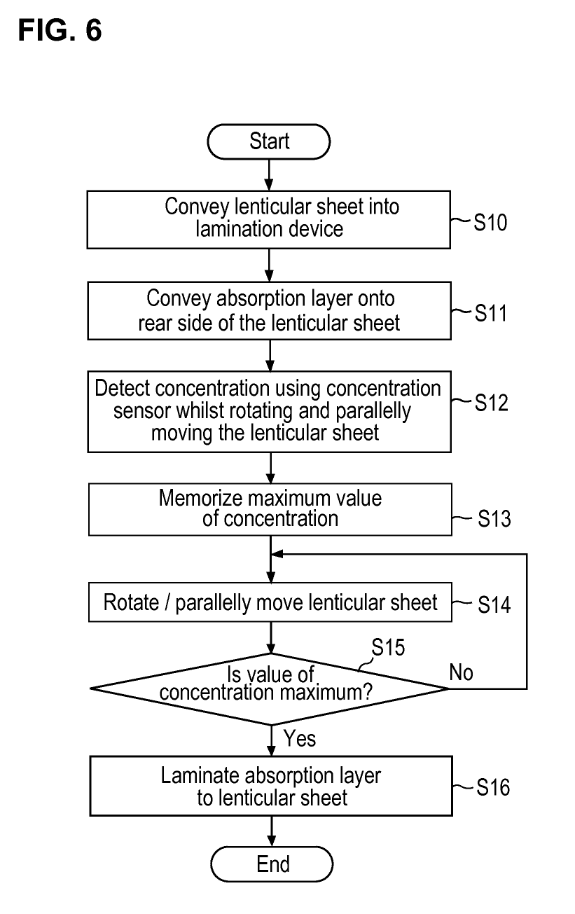

FIG. 6 is a flowchart showing the manufacturing process of the image print sheet 100. This process is executed using a control part (not-shown) of the attachment apparatus 110.

A lenticular sheet 101 is inserted from an insertion opening of the attachment apparatus 110 into the attachment apparatus 110 with its rear surface facing upward (refer to the dotted lines in FIG. 7). Then, a conveying part (not-shown) will convey the lenticular sheet 101 to the position where it covers a density sensor 111 (Step S10).

The attachment apparatus 110 is mainly composed of, as shown in FIG. 7, insertion openings (not shown) which a lenticular sheet 101 and reception layer 102 are inserted respectively, conveying part (not shown) conveying the lenticular sheet 101 and reception layer 102 respectively, a density sensor 111 provided on the front surface of the lenticular sheet 101 and a thermal head 112 provided on the rear surface of the lenticular sheet 101. The density sensor 111, for example, can be an area sensor.

Then, a reception layer sheet 102 is inserted from an insertion opening of the attachment apparatus 110 (refer to the dotted lines in FIG. 7).

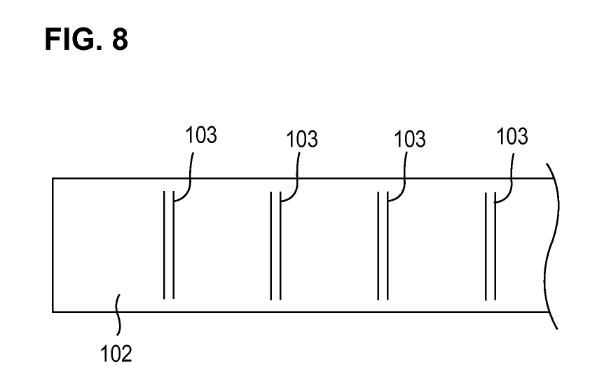

The reception layer sheet 102 is manufactured by making one surface of a sheet consisting of only an ink reception layer thermally adhesive, and then printing a detection pattern 103 on the surface that is not made thermal adhesive. The detection pattern 103 consists of two parallel lines spaced at a distance nearly equal to the pitch of the convex parts 101a. As shown in FIG. 8, such detection patters 103 are printed in multiple at predetermined distance. Note that, the method for manufacturing a reception layer sheet 102 is not restricted to this process. For example, it is possible to print a detection pattern 103 on one surface of the reception layer sheet 102, and then making the surface on which the detection pattern 103 is printed thermally adhesive, or to print a detection pattern 103 on one surface of the reception layer sheet 102 and then making the surface on which the detection pattern 103 is not printed thermally adhesive.

Here, the reception layer sheet 102 manufactured as described above is inserted in the attachment apparatus 110 with the thermal adhesive surface facing down. The inserted reception layer sheet 102 is conveyed onto the rear surface of the lenticular sheet 101 by a not-shown conveying part (Step S11). Consequently, the reception layer sheet 102 is placed on the rear surface of the lenticular sheet 101.

Note that, in this embodiment, the lenticular sheet 101 and reception later sheet 102 are inserted in the attachment apparatus 110 in this order, whereas the order of insertion can be reversed.

After the lenticular sheet 101 and reception layer sheet 102 are conveyed, the density sensor 111 measures the optical density while the conveying part rotates and parallelly-moves the lenticular sheet 101 (Step S12). Since the detection pattern 103 consisting of two lines is printed on the reception layer sheet 102, it is desirable that both lines are included in the detection range of the density sensor 111.

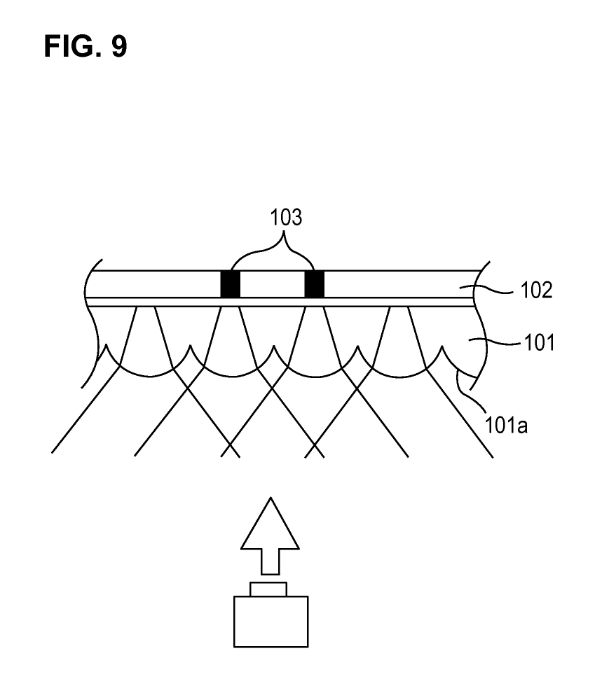

As shown in FIG. 9, since the convex parts 101a have a nearly arc-shaped cross-section, the image printed at position nearly coinciding with the vertexes of the convex parts 101a is enlarged. Therefore, the density sensor 111 yields the maximum detection result when the detection pattern 103 is parallel to the longitudinal direction of the convex parts 101a and coincides with the vertexes of the convex parts 101a. Wherein, the density sensor 111 yields the minimum detection result when the detection pattern 103 is parallel to the longitudinal direction of the convex parts 101a and coincides with the troughs between the convex parts 101a. When the detection pattern 103 is not parallel to the longitudinal direction of the convex parts 101a or the detection pattern 103 does not coincide with the vertexes of the convex parts 101a, or the detection pattern 103 does not coincide with the troughs between the convex parts 101a, a value between the maximum and minimum values will be obtained.

In Step S12, for example, the lenticular sheet 101 will parallelly-move in a predetermined distance and rotate in a predetermined angle, and then the density is measured, with the same process being repeated. In this way, the maximum value among the densities measured in Step S12 is stored in a memory (not shown) of the control part or the like (Step S13).

The conveying part rotates and parallelly-moves the lenticular sheet 101 and the density sensor 111 measures the optical density (Step S14). It is determined whether the measured density is equal to the maximum value stored in the Step S13, namely whether the detection pattern 13 is parallel to the longitudinal direction of the convex parts 101a and coincides with the vertexes of the convex parts 101a (Step S15).

When the measured density is not equal to the maximum value stored in Step S13 (“NO” in Step S15), the step of rotating and parallelly-moving the lenticular sheet 101 and measuring the optical density using the density sensor 111 (Step S14) will be repeated.

When the measured density is equal to the maximum value stored in Step S13 (“YES” in Step S15), the detection pattern 103 or the reception layer sheet 102 and the lenticular sheet 101 have an appropriate positional relationship. Therefore, the thermal head 112 thermally attaches the reception layer sheet 102 to the lenticular sheet 101 (Step S16). When the thermally adhesive surface and the surface on which the detection pattern 103 is printed are the same, the surface on which the detection pattern 103 is printed is attached to the lenticular sheet 101. When the surface that is not thermally adhesive and the surface on which the detection pattern 103 is printed are different, the surface opposite to the one on which the detection pattern 103 is printed (the surface on which the detection pattern 103 is not printed) is attached to the lenticular sheet 101.

In this way, the image print sheet 100 having the detection pattern 103 parallel to the longitudinal direction of the convex parts 101a and coinciding with the vertexes of the convex parts 101 is manufactured. Furthermore, the lenticular sheet 101 and reception layer sheet 102 can be aligned with a simple configuration of measuring the density from the rear surface of the lenticular sheet 101 without measuring their positions separately.

In this embodiment, the detection pattern 103 is parallel to the longitudinal direction of the convex parts 101a and coincides with the vertexes of the convex parts 101a. However, the detection pattern 103 does not need to coincide with the vertexes of the convex parts 101a as long as it is parallel to the longitudinal direction of the convex parts 101a.

For example, the detection pattern 103 can coincide with the troughs between the convex parts 101a. In such case, the standard of detection value of the density sensor 111 can be set to the minimum value.

Furthermore, it is sufficient that the detection pattern 103 is parallel to the longitudinal direction of the convex parts 101a without being aligned with respect to the convex parts 101a. In such case, there is no need of parallel-moving the lenticular sheet 101 in Steps S12 and S14. When the detection pattern 103 is parallel to the longitudinal direction of the convex parts 101a, the detection pattern 103 is detected having a constant thickness because the lens effect is constant. Therefore, it can be determined whether the detection pattern 103 is parallel to the longitudinal direction of the convex parts 101a by determining whether the detection pattern 103 detected upon printing has a constant thickness. However, from the viewpoint of easily detecting the detection pattern 103 upon printing, it is desirable that the detection pattern 103 coincides with the vertexes of the convex parts 101a.

Moreover, in this embodiment, the density sensor 111 is used to measure the density of the detection pattern 103 so as to align the lenticular sheet 101 and reception layer sheet 102. The lenticular sheet 101 and reception layer sheet 102 can be aligned by detecting the thickness of the lines of the detection pattern 103. When the detection pattern 103 is parallel to the longitudinal direction of the convex parts 101a, the detection pattern 103 has a constant thickness. Therefore, it can be determined whether the detection pattern 103 is parallel to the longitudinal direction of the convex parts 101a. Furthermore, the detection pattern 103 is detected having the maximum thickness when the detection pattern 103 coincides with the vertexes of the convex parts 101a, and the detection pattern 103 is detected having the minimum thickness when the detection pattern 103 coincides with the troughs of the convex parts 101a, from which the detection pattern 103 and convex parts 101a can be aligned.

### [Explanation for the Operation of the Printing Apparatus]

Operation of the printing apparatus 10 will be described hereafter.

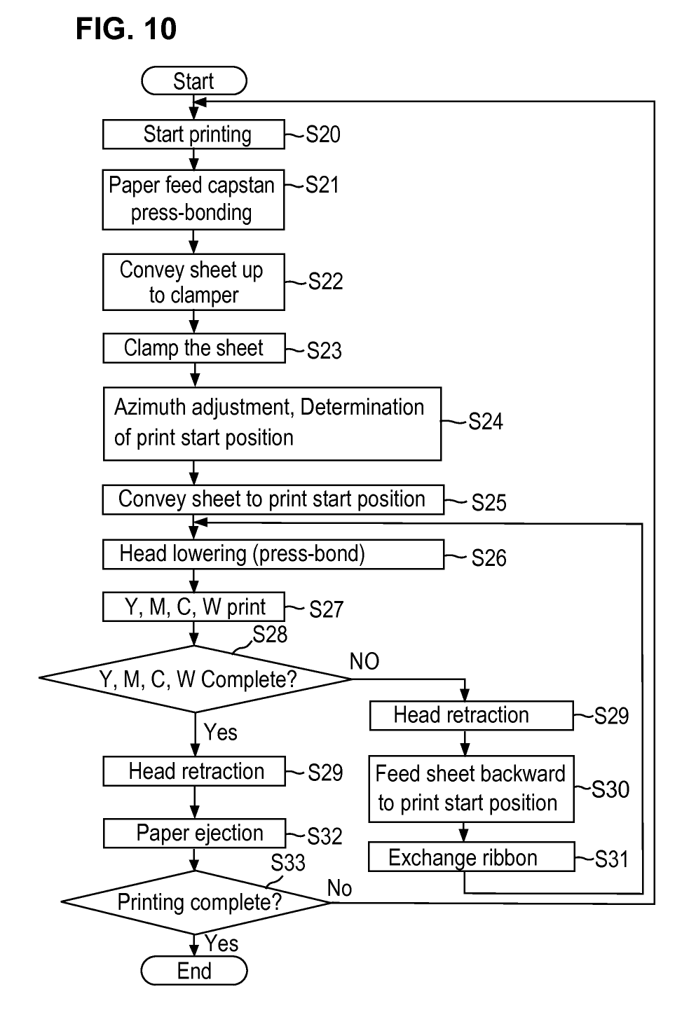

FIG. 10 is a flowchart showing the printing process of the printing apparatus 10. Explanation will be made hereinafter with reference to this flowchart. The printing process is controlled by the system controller 50. The programs allowing the system controller 50 to execute this printing process are stored in the program storage part 51.

After two-viewpoint images (right and left images) are stored in the buffer memory 52 from a PC via the communication I/F 55 and the print start switch of the operation part 54 is turned on, the YMC analysis/image processing part 56 generates 3D print data and the printing starts. Note that, print start and other instructions can be entered from a PC connected to the communication I/F 55 (Step S20).

The capstan 24 is pressed against the conveying roller 22 so that the image print sheet 100 is held between the conveying roller 22 and capstan 24 (Step S21). The image print sheet 100 has been inserted from a not-shown insertion opening. The leading end of the image print sheet 100 inserted from the insertion opening has reached the position of the conveying roller 22. Then, as the capstan 24 is pressed against the conveying roller 22, the image print sheet 100 is automatically held between them. Note that, the capstan 24 can be press-bonded against the conveying roller 22 in advance so that the image print sheet 100 is held between the conveying roller 22 and capstan 24 as it is inserted.

Subsequently, the system controller 50 drives the conveying roller 22 for a predetermined period of time to conveying the image print sheet 100 to the clamper 30 (Step S22). Here, the clamper 30 is on standby state at the initial position. As the leading end of the image print sheet 100 abuts the clamper 30, the conveying roller 22 runs idle. Furthermore, as the image print sheet 100 abuts the clamper 30, the image print sheet 100 is roughly positioned.

The system controller 50 drives the open/close mechanism 31 to close a pair of clamping members by the biasing force of a spring so that the clamper 30 clamps the image print sheet 100 (Step S23), and performs azimuth adjustment and print start position determination (Step S24).

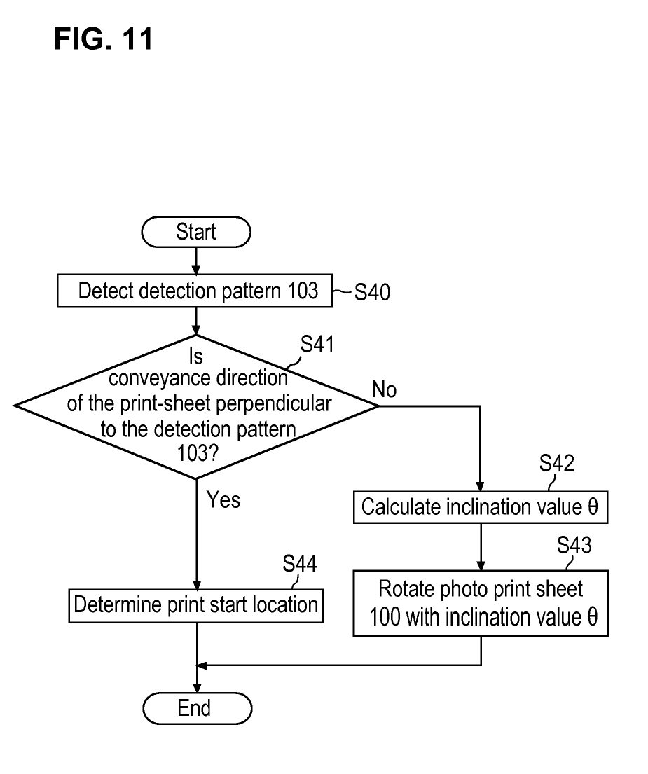

FIG. 11 is a flowchart showing the azimuth adjustment and print start position determination process (Step S24).

The system controller 50 moves the clamper 30 for a predetermined period of time at a predetermined speed and acquires detection signals from the photo-interrupters 40 and 42 to detect the detection pattern 103 (Step S40). In Step S40, detection signals detected by the photo-interrupters 40 and 42 are acquired while the photo-interrupters 40 and 42 are stopped at predetermined positions and the clamper 30 is moved at a predetermined speed.

The system controller 50 determines whether the conveying direction of the image print sheet is perpendicular to the longitudinal direction of the convex parts 101a, namely to the detection pattern 103 based on the detection signals detected by the photo-interrupters 40 and 42 (Step S41).

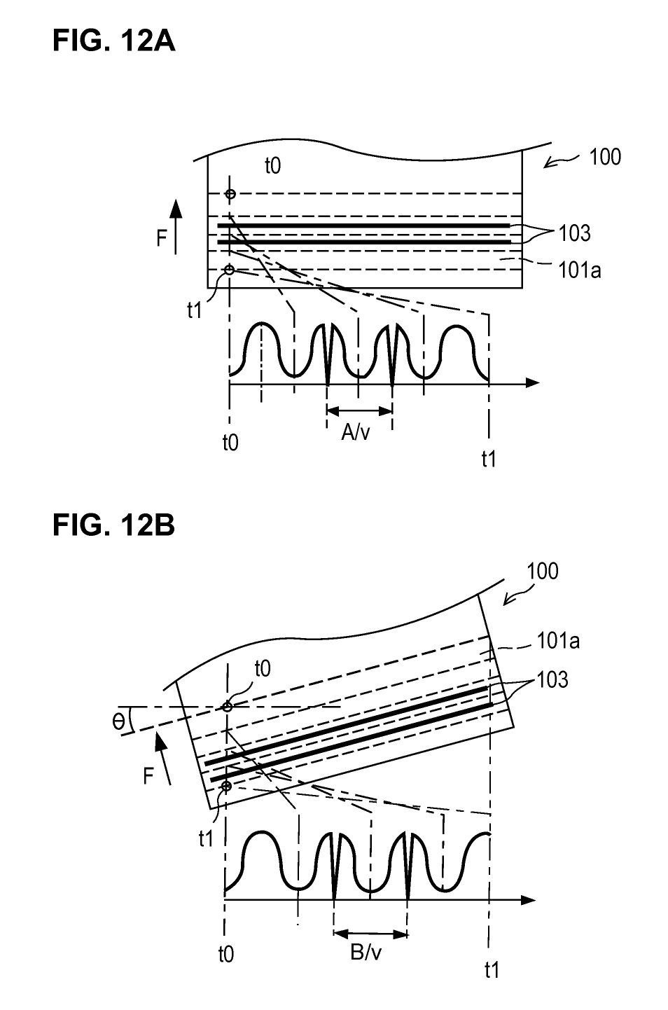

FIGS. 12A and 12B are schematic views showing the relationship between the conveying direction of the image print sheet 100 and the detection results of the photo-interrupters 40 and 42 (FIG. 12A) when the conveying direction of the image print sheet 100 is nearly perpendicular to the longitudinal direction of the convex parts 101a, and (FIG. 12B) when the conveying direction of the image print sheet 100 is not perpendicular to the longitudinal direction of the convex parts 101a.

In FIGS. 12A and 12B, detection signals are acquired from the photo-interrupters 40 and 42 at a time t0 to t1 while the image print sheet 100 is conveyed in the arrowed direction F at a speed v.

The detection signals detected on the image print sheet 100 by the photo-interrupter 42 have the maximum value when the photo-sensor optical axis coincides with the centers of the convex parts 101a of the image print sheet 100 and have the minimum value when the photo-sensor optical axis coincides with the troughs between the convex parts 101a. Furthermore, the detection signals are nearly equal to zero when the photo-sensor optical axis coincides with the positions where the detection pattern 103 is printed.

When the conveying direction of the image print sheet 100 is nearly perpendicular to the longitudinal direction of the convex parts 101a, signals having a value 0 due to the detection pattern 103 are detected at a time interval of A/v as shown in FIG. 12A. When the conveying direction of the image print sheet 100 is not nearly perpendicular to the longitudinal direction of the convex parts 101a, signals having a value 0 due to the detection pattern 103 are detected at a time interval of B/v longer than A/v as shown in FIG. 12B.

As described above, it can be determined whether the conveying direction of the image print sheet 100 is perpendicular to the longitudinal direction of the convex parts 101a, namely to the detection pattern 103 based on the time lag in detection of signals having a value 0 due to the detection pattern 103.

When the conveying direction of the image print sheet 100 is not perpendicular to the longitudinal direction of the convex parts 101a, namely to the detection pattern 103 (“NO” in Step S41), the system controller 50 calculates the tilting rate 0 (refer to FIGS. 12A and 12B) based on the mathematical equation 1 (Step S42) and rotates the image print sheet 100 by the tilting rate θ using the sheet conveying mechanism 431 (Step S43), then returning to the step of detecting the detection pattern 103 (Step S40).

tilting rate θ=cos⁻¹(a/b) [Equation 1]

When the conveying direction of the image print sheet 100 is perpendicular to the longitudinal direction of the convex parts 101a, namely to the detection pattern 103 (“YES” in Step S41), the system controller 50 determines the print start position based on the detection results of the detection pattern 103 (Step S44).

The pitch A of the convex parts 101a and the positions of the troughs between convex parts 101a are determined based on the results of detecting the two lines of the detection pattern 103. Based on the detection results, for example, the image print sheet 100 is moved back by predetermined pitches from between the two lines of the detection pattern 103 to define the print start position. The print start position is not restricted thereto and can be at a vertex of the convex parts 101a, namely the position of the detection pattern.

No matter how the print start position is determined, the images are overlapped and printed on the detection pattern 103. Therefore, there is no need of reserving a marginal region for recording the detection pattern 103 and the image print sheet can efficiently be used. In this regard, it is desirable that the detection pattern 103 is so recorded as to coincide with the troughs between convex parts 101a.

Then, the azimuth adjustment and print start position determination step (Step S24) is completed and the relative position between the lens position of the image print sheet 100 and the print position of a six-viewpoint image is adjusted. In this way, a three-dimensional image can be printed with high accuracy by using the detection pattern 103 upon printing.

The system controller 50 controls the head moving mechanism 432 via the head movement control part 422 so that the thermal head 14 is pressure-contacted against the platen roller 20 via a desired ink ribbon Y, M, C or W and the image print sheet 100 (Step S26).

The system controller 50 rotates the drive motor 44 via the sheet conveying control part 421 to drive the clamper 30 and move the image print sheet 100 forward (refer to the arrow F in FIGS. 1 to 3). Synchronizing with this operation, the system controller 50 rewinds the ink ribbon on the rewind reel 16 at a speed slightly faster than the moving speed of the image print sheet 100 via the ink ribbon drive mechanism 433 and energizes the thermal head 14 to generate heat. Then, a heated color material is transferring from the desired ink ribbon Y, M, C or W to the image print sheet 100 to form an image (Step S27).

The system controller 50 determines whether the heated color material is transferred from all color, Y, M, C and W, ink ribbons to the image print sheet 100 to form an image (Step S28).

If all the color, Y, M, C and W ink ribbons are not used for printing (“NO” in Step S28), the system controller 50 controls the head moving mechanism 432 via the head movement control part 422 to move the thermal head 14 to the position where it does not interfere with the ink ribbons (Step S29). Then, the system controller 50 controls the sheet conveying mechanism 431 via the sheet conveying control part 421 to move back the image print sheet 100 to the print start position (cue position) (Step S30) and controls the ink ribbon drive mechanism 433 via the ink ribbon control part 423 to rotate the ribbon cage 12 to the position of the next color ink ribbon to be set (Step S31). After the sheet cue (Step S30) and ink ribbon exchange (Step S31) are done, return to Step S27, where the color of the next ink ribbon set is transferred to the print side of the image print sheet 100.

After all color, i.e. Y, M, C and W, ink ribbons are used for printing (“YES” in Step S28), the system controller 50 controls the head moving mechanism 432 via the head movement control part 422 to move the thermal head 14 to the position where it does not interfere with the ink ribbons (Step S29). Then, after all color printing, the system controller 50 cuts off predetermined regions of the image print sheet 100 at the leading and rear ends with a not-shown cutter and ejects the image print sheet 100 by means of a not-shown ejecting mechanism (Step S32).

The system controller 50 determines whether all sheets are printed (Step S33). When all sheets are printed (“YES” in Step S33), the process ends. When not all sheets are printed (“NO” in Step S33), return to Step S20 and start the feeding of the next sheet.

As described above, in this embodiment, a reception layer sheet on which a detection pattern is printed is attached to a lenticular sheet. With this simple method, an image print sheet on which a detection pattern is recorded can be manufactured. Furthermore, using the method of attaching a reception layer sheet on which a detection pattern is printed to a lenticular sheet, an image print sheet on which a detection pattern is recorded can be provided to the user. Then, using the image print sheet on which a detection pattern is printed for printing, the user can print three-dimensional images with high accuracy.

Furthermore, in this embodiment, an image is printed on the detection pattern. In other words, the detection pattern is recorded in the print region. Therefore, there is no need of reserving a marginal region for recording the detection pattern and the image print sheet can efficiently be used.

Furthermore, in this embodiment, using an image print sheet on which a detection pattern is recorded, the tilting rate and pitch of convex parts of the image print sheet can be obtained by the same simple structure as a conventional printer apparatus. Furthermore, with the detection pattern consisting of multiple lines, the tilting rate, pitch of convex parts, and print start position of the image print sheet can be obtained without moving the photo-interrupters 40 and 42.

In this embodiment, the detection pattern 103 is detected by moving the clamper 30 for a predetermined period of time at a predetermined speed and acquiring detection signals using the photo-interrupters 40 and 42 (Step S40). The method of detecting the detection pattern 103 is not restricted thereto.

For example, it is possible to move the clamper 30 until the photo-interrupters 40 and 42 detect the detection pattern, stop the clamper 30, and acquire detection signals using the photo-interrupters 40 and 42 while moving them in parallel to the platen roller 20. In this way, azimuth adjustment is available. In such a case, the detection pattern can consist of one line. Even though the detection pattern consists of one line, the direction of the convex parts 101a of the image print sheet 100 can be identified by detecting the detection pattern 103.

Instead of moving a set of photo-interrupters 40 and 42 in parallel to the platen roller 20, multiple sets of photo-interrupters can be provided in parallel to the platen roller 20.

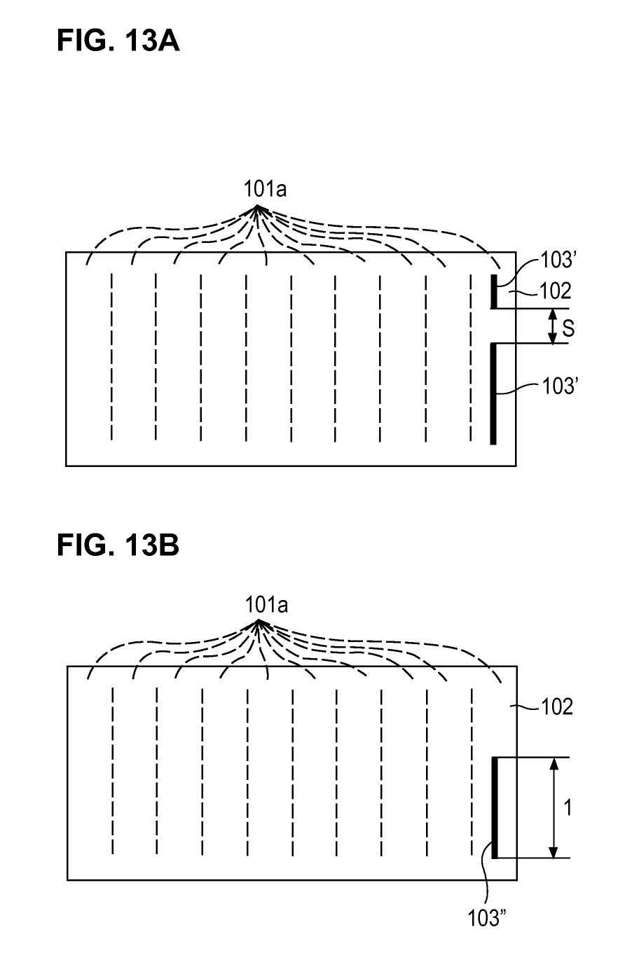

Furthermore, in this embodiment, the detection pattern consisting of two lines spaced at a distance equal to the pitch A of the convex parts 101a is used to detect the pitch A of the convex parts 101a and the positions of the troughs between convex parts 101a. The detection pattern 103 for detecting the pitch A of the convex parts 101a is not restricted thereto. FIGS. 13A and 13B show another embodiment of detection patterns 103′ and 103″ that can detect pitch A.

The detection pattern 103′ shown in FIG. 13A consists of two lines aligned in the direction parallel to the longitudinal direction of the convex parts. The distance s between the two lines (the distance in the longitudinal direction of the convex parts) is designed to indicate the pitch. Therefore, the pitch A can be detected by detecting the distance s upon printing. Here, the number of lines aligned is not restricted to two. Three or more lines can be aligned. When there are three or more lines, the pitch A can be presented by an individual distance between lines or by the number of lines.

The detection pattern 103″ shown in FIG. 13B consists of one line. The length L of the line presents the pitch. Therefore, the pitch A can be detected by detecting the length L of the line upon printing.

The applicable range of the present invention is not restricted to sublimation printers using ink ribbons, and moreover, the print medium is not restricted to lenticular sheets having a lens side and a print side. The present invention is applicable to various systems forming an image on a print medium while reciprocating the print medium along the conveying path (such as thermo-autochrome (TA) printers, inkjet printers, molten-type thermal transferring system, silver halide photography (thermal development transferring) system, zero ink (registered trademark)).

What is claimed is:

1. A method for manufacturing an image print sheet, including:
a printing step for printing a pattern on an optically transparent reception layer sheet; and
an attachment step for attaching the reception layer sheet printed with the pattern to a flat surface of a lenticular sheet, the lenticular sheet being provided with a strips of convex part having nearly arc-shaped cross-section which are continuously aligned in parallel to each other on one surface of an optically transparent substrate meanwhile the flat surface is on the other surface of the optically transparent substrate.

2. The method for manufacturing an image print sheet according to claim 1, wherein:
in the printing step, one or more lines are printed as the pattern on the reception layer sheet; and
in the attachment step, the reception layer sheet is attached to the lenticular sheet in a manner that the pattern is parallel to the longitudinal direction of the convex part.

3. The method for manufacturing an image print sheet according to claim 2, wherein:
in the attachment step, the reception layer sheet is attached to the lenticular sheet in the manner that the pattern coincides with the vertex of the convex parts or the trough between the convex parts.

4. The method for manufacturing a print sheet according to claim 2, wherein:
in the printing step, two or more lines are printed as the pattern aligned in an distance equal to the distance between the convex parts.

5. The method for manufacturing an image print sheet according to claim 2, wherein:
in the printing step, two or more lines are printed as the pattern aligned in a row with a predetermined distance.

6. The method for manufacturing an image print sheet according to claim 1, wherein:
the method further includes a step of making a predetermined surface of the reception layer sheet adhesive, wherein:
in the printing step, the pattern is printed on the surface that is not made adhesive; and
in the attachment step, the surface that is made adhesive is attached to the flat surface.

7. The method for manufacturing an image print sheet according to claim 1, wherein:
in the printing step, the pattern is printed on a predetermined surface;
the method further includes a step of making the surface on which the pattern is printed or the surface on which the pattern is not printed adhesive; and
in the attachment step, the adhesive side is attached to the flat surface.

8. The method for manufacturing an image print sheet according to claim 1, wherein the attachment step comprising:
a first step for placing the reception layer sheet on which a pattern is printed on to the flat surface of the lenticular sheet;
a second step for detecting the pattern from the side of the lenticular sheet on which the convex parts are formed;
a third step for determining whether the reception layer sheet and lenticular sheet have an appropriate positional relationship based on the detected results in the step of detecting the pattern; and
a fourth step for attaching the reception layer sheet to the lenticular sheet when the appropriate positional relationship is confirmed in the step of determination.

9. The method for manufacturing an image print sheet according to claim 8, wherein:
in the second step, the density of a predetermined region is detected; and
in the third step, the appropriate positional relationship is confirmed when the predetermined region has the maximum density or the minimum density.

10. The method for manufacturing an image print sheet according to claim 8, wherein:
in the second step, the thickness of the pattern is detected; and
in the third step, the appropriate positional relationship is confirmed when the pattern has a constant thickness.

11. The method for manufacturing an image print sheet according to claim 10, wherein in the third step, the appropriate positional relationship is confirmed when the pattern has the maximum thickness or the minimum thickness.

12. An image print sheet, comprising:
a lenticular sheet having multiple half-cylinder or arc-shaped elongated convex parts aligned on one surface of an optically transparent substrate where the other surface of an optically transparent substrate is flat surface; and
an optically transparent reception layer sheet placed on the flat surface of the lenticular sheet and on which a linear pattern parallel to the convex parts coinciding with the centers of the convex parts or the troughs between the convex parts is printed.

13. The image print sheet according to claim 12, wherein two or more lines are printed as the pattern in a distance equal to the distance between the convex parts on the reception layer sheet.

14. The image print sheet according to claim 12, wherein:
two or more lines are printed in a row as the pattern in a predetermined distance on the reception layer sheet.

15. The image print sheet according to claim 12, wherein:
the image print sheet has marginal regions near the ends of the image print sheet and an image print region in which an image is printed; and
the pattern is printed in the image print region.

16. A printing apparatus for printing using the image print sheet produced by the method for manufacturing image print sheet according to claim 1, wherein the image print sheet comprising:
a conveying part for conveying the image print sheet;
a detection part for detecting the pattern on the image print sheet conveyed by the conveying part;
a rotation part for rotating the image print sheet based on the pattern detected by the detection part; and
a print part for printing the image on the image print sheet based on the pattern detected by the detection part.

17. The printing apparatus according to claim 16, the apparatus comprising a determination part determining the print start position based on the pattern detected by the detection part,
wherein the print part makes a print from the print start position determined by the determination part.
